(19) United States
(12) Patent Application Publication
(10) Pub. No.: US 2021/0215736 A1
(43) Pub. Date: Jul. 15, 2021

(54) METHOD FOR CALIBRATING A SENSOR OF A DEVICE AND SENSOR SYSTEM

(71) Applicant: Robert Bosch GmbH, Stuttgart (DE)

(72) Inventor: Juergen Gut, Tuebingen (DE)

(21) Appl. No.: 17/056,159

(22) PCT Filed: Jun. 18, 2019
(86) PCT No.: PCT/EP2019/066059

§ 371 Date: Nov. 17, 2020

(30) Foreign Application Priority Data
Aug. 22, 2018 (DE) 10 2018 214 156.8

(51) Int. Cl. G01P 21/00; G01P 1/00; G01P 15/00

(52) U.S. Cl. CPC G01P 21/00; H04L 67/10; G01P 15/00; G01P 1/00

(57) ABSTRACT

A method for calibrating a sensor of a device. The sensor includes a sensor element for detecting a measured variable and an evaluation device for evaluating a raw signal provided by the sensor element. The method includes providing an intermediate signal by the evaluation device, providing calibration information for the sensor based on the identification information of the sensor with the aid of a calibration information provision device, calibrating the intermediate signal with the aid of the calibration information by a calibration device, and providing a wanted signal based on the calibrated intermediate signal by the calibration device, the calibration information provision device and/or the calibration device being situated outside of the sensor and connected thereto.

### FIELD

The present invention relates to a method for calibrating a sensor of a device, the sensor including a sensor element for detecting a measured variable and an evaluation device for evaluating a raw signal provided by the sensor element.

The present invention further relates to a sensor system.

### BACKGROUND INFORMATION

Although the present invention is applicable in general to any arbitrary sensors, the present invention is described in relation to MEMS sensors.

Conventional sensors that are based on the micro-electromechanical system technology, in short MEMS technology, for example, include two components, for example, the actual sensor element and an associated evaluation logic. In this case, the evaluation logic assumes various tasks, including signal conversion, processing and calibration, among other things. In the case of a calibration, the signal converted by the sensor element is changed in such a way that it responds preferably ideally to a change in the physical input variable at the output of the evaluation logic. Common errors that are corrected by the calibration are the sensitivity and offset, among other things, which are present in the raw signal provided by the sensor element. Oftentimes, these parameters are also a function of environmental influences, such as temperatures or humidity, for example, which may be additionally corrected with the aid of the calibration. In order to be able to correct the inaccuracies of the sensors by a calibration, the calibration parameters to be determined are usually ascertained during the manufacturing process of the sensor by testing systems or other production facilities and integrated specifically for each component in the evaluation logic of the particular sensor or stored in same in the sensor during the production process. In this way, calibration parameters for the offset and the sensitivity of a sensor may be ascertained during the manufacturing process, for example, and stored directly in the evaluation logic of the sensor.

### SUMMARY

In one specific example embodiment, the present invention provides a method for calibrating a sensor in a device, the sensor including a sensor element for detecting a measured variable and an evaluation device for evaluating a raw signal provided by the sensor element, including the steps:
providing an intermediate signal by the evaluation device,
providing calibration information for the sensor based on identification information of the sensor with the aid of a calibration information provision device,
calibrating the intermediate signal with the aid of the calibration information with the aid of a calibration device, and
providing a wanted signal based on the calibrated intermediate signal by the calibration device,

the calibration information provision device and/or the calibration device being situated outside of the sensor and connected thereto.

In a further specific example embodiment, the present invention provides a sensor system, including a device, in particular a mobile device, which includes a sensor, in particular an MEMS sensor, the sensor including a sensor element for detecting a measured variable and an evaluation device for evaluating a raw signal provided by the sensor element and for outputting an intermediate signal, a calibration device for calibrating an intermediate signal provided by the evaluation device with the aid of the calibration information and for providing a wanted signal based on the calibrated intermediate signal, and a calibration information provision device for providing calibration information for the sensor based on the identification information of the sensor, the calibration information provision device and/or the calibration device being situated outside of the sensor and connected thereto.

One of the advantages that may be achieved thereby is that the calibration information provision device and/or the calibration device no longer need to be situated within the sensor and thus a smaller and more cost-effective component may be implemented. Moreover, the flexibility is increased, since errors in the evaluation device that could not subsequently be corrected due to the previously directly stored calibration parameters may now be corrected, for example. Likewise, the development time and development costs of a sensor may be reduced, since the calibration device implemented as an ASIC for example, which is comparably complex and expensive, no longer has to be situated within the sensor.

Further features, advantages, and further specific embodiments of the present invention are described below or provided as a result thereof.

According to one advantageous refinement of the present invention, the calibration information is provided by a server, in particular a cloud server. This allows for a simple, fast and central access to the calibration information for a plurality of different sensors.

According to a further advantageous refinement of the present invention, the identification information of the sensor includes a unique identification number. In this way, a sensor may be identified in a simple and rapid manner, for which it is then possible to accordingly provide calibration information.

According to a further advantageous refinement of the present invention, the identification information is provided in the form of a barcode to a user of the device. In this way, a user may easily connect his/her device himself/herself after start-up to the calibration information provision device in a controlled manner and transmit appropriate identification information of a sensor.

According to a further advantageous refinement of the present invention, the calibration device is situated on the device. In this way, a calibration of the sensor may be carried out directly on the device. The calibration may be implemented as a software on a processing unit, for example.

According to a further advantageous refinement of the present invention, the intermediate signal is transferred to the calibration device, which is situated outside of the device, and the wanted signal is transferred back to the device. In this way, an even more compact design of the sensor or of the device is possible. At the same time, a calibration device may be made available centrally, thus improving the flexibility with regard to possible updates, etc., for the calibration device.

According to a further advantageous refinement of the present invention, the wanted signal is transferred to a function unit that provides at least one function on the basis of the wanted signal to a user of the device. The so-called “user experience” is thus improved.

According to a further advantageous refinement of the sensor system in accordance with the present invention, the calibration information provision device is designed in the form of a server, in particular of a cloud server, which is connectable to the device. One of the advantages thus achieved is that the calibration information may be provided in a simple manner for a plurality of sensors.

According to a further advantageous refinement of the sensor system of the present invention, the calibration device is designed in the form of a server, in particular of a cloud server, which is connectable to the device. In this way, the device may be designed even more compactly.

According to a further advantageous refinement of the sensor system of the present invention, the sensor system includes a function unit designed to provide a function for a user of the device, the function unit being designed in the form of a server, in particular a cloud server. In this way, the device may be designed even more compactly and cost-effectively.

According to a further advantageous refinement of the sensor system of the present invention, the calibration device and the function unit are located on the same server. In this way, a cost-effective and central implementation of the function unit and calibration device is possible.

Further important features and advantages of the present invention result from the figures, and from the associated description of the figures based on the figures.

It is understood that the above-mentioned features and the features to be elucidated below are usable not only in the given combination, but also in other combinations or alone without departing from the scope of the present invention.

Preferred embodiments and specific embodiments of the present invention are shown in the figures and are elucidated in greater detail in the description below, identical reference numerals referring to identical or similar or functionally identical components or elements.

### DETAILED DESCRIPTION OF THE DRAWINGS

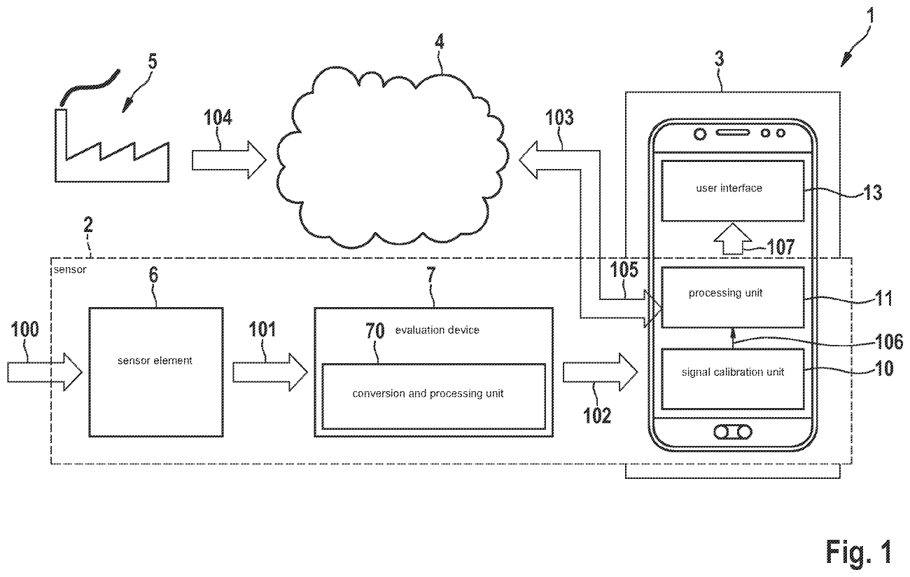

FIG. 1 schematically shows a sensor system according to one specific embodiment of the present invention.

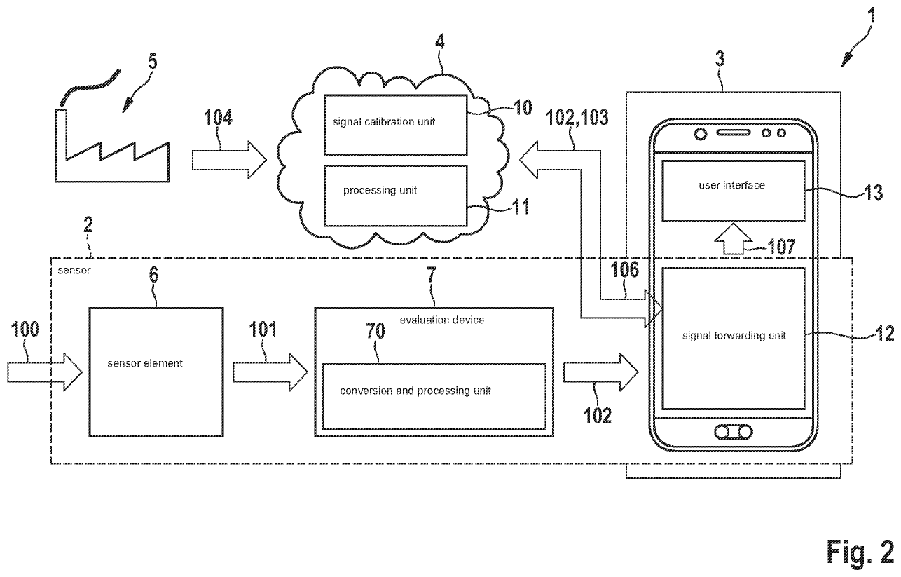

FIG. 2 schematically shows a sensor system according to one specific embodiment of the present invention.

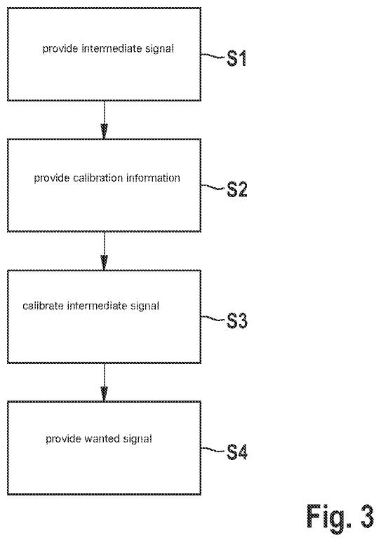

FIG. 3 schematically shows the steps of a method according to one specific embodiment of the present invention.

### DETAILED DESCRIPTION OF EXAMPLE EMBODIMENTS

FIG. 1 schematically shows a sensor system according to one specific embodiment of the present invention.

In FIG. 1, a sensor system 1 is shown. Sensor system 1 includes a sensor 2 situated in a device 3. Sensor 2 includes a sensor element 6 and an evaluation device 7. A signal calibration unit 10 and a processing unit 11, which provides functions 107 for a user interface 13 based on wanted signal 106, are further situated on device 3. Device 3 is further connected to a server 4 that provides a cloud service. A manufacturer 5 of sensor 2 provides calibration parameters 104 to server 4, which server 4 in turn provides to device 3 upon request.

In detail, sensor element 6 now measures a measured variable 100, for example an acceleration or the like. Sensor element 6 makes a raw signal 101, which is based on measured variable 100, available to evaluation device 7 that processes raw signal 101 with the aid of a conversion and processing unit 70 and provides an intermediate signal 102. Intermediate signal 102 is made available to signal calibration unit 10 that provides a wanted signal 106 based on calibration parameters 105, which are requested by server 4 based on a sensor identification number of server 4 for sensor 2 (reference numeral 103) and which are transferred to device 3. Based on wanted signal 106, processing unit 11 makes functions 107 available to a user interface 13 of device 3.

In other words, the hardware portion of sensor 2 includes sensor element 6 as well as a component 7 for signal conversion and processing. The calibration of the sensor signals takes place by software on a processing unit 11 of device 3, which retrieves from a server 4 calibration parameters 104, 105 ascertained in the manufacturing process, in the form of a cloud service in the present case, with the aid of a unique identification number that belongs to sensor element 6, and uses them for the calibration of the sensor signals. The identification number of sensor 2 may be delivered visually as a barcode together with sensor 2, for example, or stored in a memory in sensor 2 or device 3. The connection between server 4 and processing unit 11 and signal calibration unit 10 may additionally be used to change the software in the course of its service life with the aid of updates.

FIG. 2 schematically shows a sensor system according to one specific embodiment of the present invention.

A sensor system 1 according to FIG. 1 is shown in detail in FIG. 2. In contrast to sensor system 1 according to FIG. 1, processing unit 11 and signal calibration unit 10 are located on server 4 in the case of sensor system 1 according to FIG. 2. Intermediate signal 102 is transferred in this case with the aid of a signal forwarding unit 12 to server 4 that receives intermediate signal 102 and sensor identification number 103. Server 4 then calibrates intermediate signal 102 with the aid of signal calibration unit 10, which receives calibration parameters 104 from a manufacturer 5 of sensor 2. Wanted signal 106 is then transferred via the connection between device 3 and server 4 to device 3. Based on wanted signal 106, processing unit 11 makes functions 107 available to a user interface 13 of device 3 on the basis of wanted signal 106.

Server 4 may also provide functions 107 for a user interface 13 of device 3 on the basis of wanted signal 106, if necessary, and transfer these separately or together with wanted signal 106 to device 3.

In other words, software 12 on device 3 is now used, for example, to send sensor signals 102, including associated sensor identification number 103, to server 4, on which the calibration of the sensor signals subsequently takes place. Calibrated sensor signals 106 and, potentially, additional functions 107 are subsequently transmitted back to software 12 on device 3, which forwards them to user 13.

FIG. 3 shows steps of a method according to one specific embodiment of the present invention.

In FIG. 3, steps of a method for calibrating a sensor in a device are shown, the sensor including a sensor element for detecting a measured variable and an evaluation device for evaluating a raw signal provided by the sensor element.

In this case, the method includes in a first step S1 a provision of an intermediate signal by the evaluation device.

Furthermore, the method includes in a further step S2 a provision of calibration information for the sensor based on the identification information of the sensor with the aid of a calibration information provision device.

Furthermore, the method includes in a further step S3 a calibration of the intermediate signal with the aid of the calibration information with the aid of a calibration device.

Furthermore, the method includes in a further step S4 a provision of a wanted signal based on the calibrated intermediate signal by the calibration device, the calibration information provision device and/or the calibration device being situated outside of the sensor and connected thereto.

To sum up, at least one of the specific embodiments of the present invention includes at least one of the following advantages:
Reduction of the sensor size.
Correction of errors “in the field,” i.e., on the device, for example through a remote connection.
Use of sensor signals from devices possible.
Reduction of the production costs.
Saving of development time and development costs.

Although the present invention has been described on the basis of preferred exemplary embodiments, it is not limited thereto, but may be modified in multiple ways.

1-12. (canceled)

13. A method for calibrating a sensor of a device, the sensor including a sensor element configured to detect a measured variable, and an evaluation device configured to evaluate a raw signal provided by the sensor element, the method comprising the following steps:
providing, by the evaluation device, an intermediate signal by the evaluation device;
providing, using a calibration information provision device, calibration information for the sensor based on identification information of the sensor using a calibration information provision device;
calibrating, by a calibration device, the intermediate signal using the calibration information; and
providing, by the calibration device, a wanted signal based on the calibrated intermediate signal;
wherein the calibration information provision device and/or the calibration device is situated outside of the sensor and is connected to the sensor.

14. The method as recited in claim 14, wherein the calibration information is provided by a server.

15. The method as recited in claim 14, wherein the server is a cloud server.

16. The method as recited in claim 13, wherein the identification information of the sensor includes a unique identification number.

17. The method as recited in claim 13, wherein the identification information is provided in the form of a barcode to a user of the device.

18. The method as recited in claim 13, wherein the calibration device is situated on the device.

19. The method as recited in claim 13, wherein the intermediate signal is transferred to the calibration device, which is situated outside of the device, and the wanted signal is transferred back to the device from the calibration device.

20. The method as recited in claim 13, wherein the wanted signal is transferred to a function unit that provides at least one function, based on the wanted signal, to a user of the device.

21. A sensor system, comprising:
a device which includes a sensor, the sensor including a sensor element configured to detect a measured variable and an evaluation device configured to evaluate a raw signal provided by the sensor element and to output an intermediate signal;
a calibration device configured to calibrate the intermediate signal provided by the evaluation device using calibration information and to provide a wanted signal based on the calibrated intermediate signal; and
a calibration information provision device configured to for provide the calibration information for the sensor based on identification information of the sensor;
wherein the calibration information provision device and/or the calibration device is situated outside of the sensor and connected to the sensor.

22. The sensor system as recited in claim 21, wherein the device is a mobile device, and the sensor is a MEMS sensor.

23. The sensor system as recited in claim 21, wherein the calibration information provision device is a cloud server, which is connectable to the device.

24. The sensor system as recited in claim 21, wherein the calibration device is a server, which is connectable to the device.

25. The sensor system as recited in claim 24, wherein the server is a cloud server.

26. The sensor system as recited in claim 24, wherein the sensor system includes a function unit configured to provide a function for a user of the device, and the function unit is a server.

27. The sensor system as recited in claim 26, wherein the server is a cloud server.

28. The sensor system as recited in claim 26, wherein the calibration device and the function unit are located on the same server.
